(19) United States
(12) Patent Application Publication
(10) Pub. No.: US 2013/0309998 A1
(43) Pub. Date: Nov. 21, 2013

(54) Method and System For Tracking Communications Between Telecommunication Devices

(71) Applicant: KoHorts IT Services, LLC, (US)

(72) Inventors: J. Robert Kamal, Brighton, MI (US); Peter Bainbridge-Clayton, Mark Cross (GB)

(21) Appl. No.: 13/888,687

(22) Filed: May 7, 2013

Related U.S. Application Data
(63) Continuation-in-part of application No. 13/740,882, filed on Jan. 14, 2013.
(60) Provisional application No. 61/586,488, filed on Jan. 13, 2012.

(51) Int. Cl. H04W 4/26

(52) U.S. Cl. CPC H04W 4/26
USPC 455/406

(57) ABSTRACT

A method of tracking communications between telecommunication devices is disclosed. The method is implemented on a processor of a first telecommunication device, where the processor has a non-transitory computer-readable storage medium with an executable application stored thereon. The method includes executing the application stored on the computer-readable storage medium. The application instructs the processor to record data when the first telecommunication device initiates an outbound call or receives an inbound call, create a call record from the recorded data, and prompt a user to designate the call record as being associated with a billable communication, a non-billable communication, or an uncategorized communication.

### CROSS REFERENCE TO RELATED APPLICATIONS

This application is a continuation-in-part of U.S. patent application Ser. No. 13/740,882, filed Jan. 14, 2013, which claims the benefit of U.S. Provisional Patent Application Ser. No. 61/586,488, filed Jan. 13, 2012. The disclosures of U.S. patent application Ser. No. 13/740,882 and U.S. Provisional Patent Application Ser. No. 61/586,488 are herein incorporated by reference in their entirety.

### BACKGROUND

1. Field of the Invention

The subject disclosure generally relates to a system architecture and method for tracking communications between telecommunication devices.

2. Description of the Related Art

Telecommunications devices, such as cell phones, smart phones, or tablets have become commonplace and often necessary fixtures of everyday life. Often these devices are issued by employers to employees for use in carrying on business or to children by parents. As such, monitoring of the usage of such devices is often necessary to ensure that the devices are not being misused and/or to ensure the safety of the user. However, comprehensive monitoring of telecommunications devices, as well as assembling data relating to such monitoring, remains a challenge. Furthermore, the second party to conversations with monitored devices may not be aware that such monitoring is taking place.

Accordingly, the subject application discloses a computerized system and method for addressing these difficulties.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a block diagram showing one embodiment of a computerized system for monitoring and recording information on telecommunication devices.

FIG. 2 is a block diagram showing schematic architecture of a software application of the computerized system.

FIG. 3 is a display view of a web browser showing a usage statistics graph for a first telecommunication device.

FIG. 4 is a display view of the web browser showing detailed usage logs for the first telecommunication device.

FIG. 5 illustrates an example of a telecommunication device.

### DETAILED DESCRIPTION

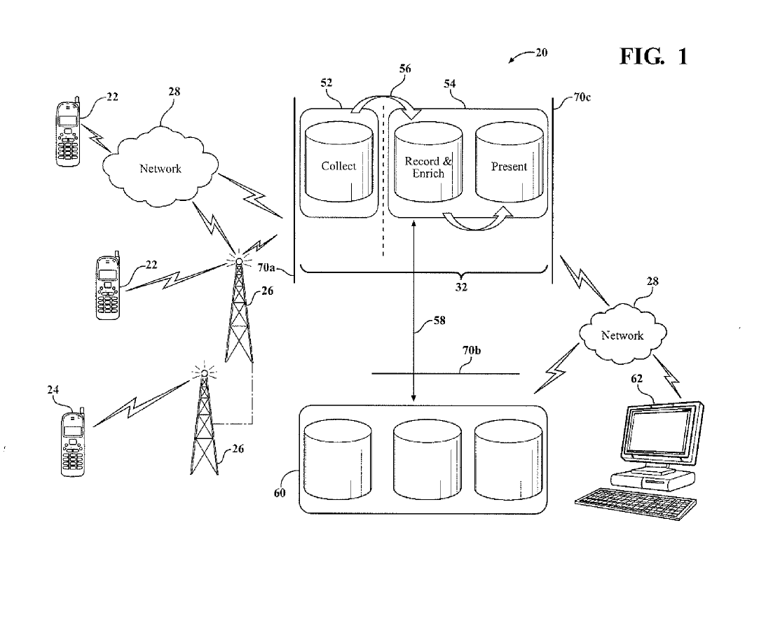

With reference to the Figures, wherein like numerals indicate like or corresponding parts throughout the several views, a computerized system 20a computerized system for dynamically controlling the behaviour of a telecommunications device in response to various telecommunications related, chronological, positional, environmental and other events and scenarios, and combinations thereof is generally shown in FIG. 1. Additionally, a method for monitoring and recording data and usage statistics of the data sent to and from the telecommunication devices is described herein.

The computerized system 20 includes a first telecommunication device 22 and a second telecommunication device 24 capable of communicating with the first telecommunication device 22. It is to be appreciated that the system 20 may include a plurality of first telecommunication devices and/or a plurality of second telecommunication devices 22, 24. However, in the interest simplicity and readability, the computerized system 20 of the present disclosure will be discussed with regard to a single first telecommunication device 22 and a single second telecommunication device 24.

The first and second telecommunication devices 22, 24 are typically capable of sending and/or receiving audible conversations and/or character-based messages. The term “audible conversations” include, but is not limited to, common and ubiquitous telephone conversations. The term “character-based messages” includes, but is not limited to, text messages utilizing short message service (SMS) and messages having multimedia content, such as pictures or video, utilizing multimedia messaging service (MMS).

The first and second telecommunication devices 22, 24 are preferably mobile phones. The mobile phones are often referred to as cellular phones, cell phones, smartphones, wireless phones, or any other suitable terms as used in the art. Alternatively, the first and second telecommunication devices 22, 24 may also include other devices, such as, but not limited to, pagers, landline phones, personal computers, laptop computers, tablet computers, electronic reading devices (e-readers), or any other device capable of sending and/or receiving audible conversations and/or character-based messages.

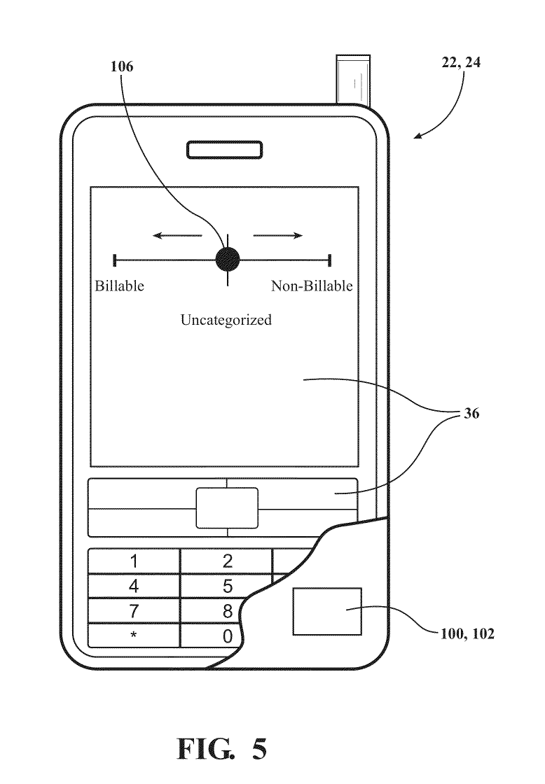

An example of the telecommunication device 22, 24 is depicted in FIG. 5. In an example, the telecommunication device 22, 24 has computing capabilities. Specifically, the first and second telecommunication devices 22, 24 each include a processor 100. The processor 100 may be any computing device, controller, microprocessor, microcontroller, application specific integrated circuit (ASIC) or other device capable of performing numerical calculations and execute software programs as is known in the art. The processor 100 may run an operating system specific to the telecommunication device 22, 24. Some suitable telecommunication devices include, but are not limited to, BlackBerry® smartphones manufactured by Research In Motion Ltd. of Waterloo, Ontario, Canada, and iPhone® smartphones manufactured by Apple Inc. of Cupertino, Calif. and Android® devices. BlackBerry® smartphones typically run BlackBerry OS operating system and iPhone® smartphones typically run iOS operating system. The BlackBerry OS operation system is substantially different than the iOS operating system such that many programs designed for the BlackBerry OS will not operate on the iOS and vice versa.

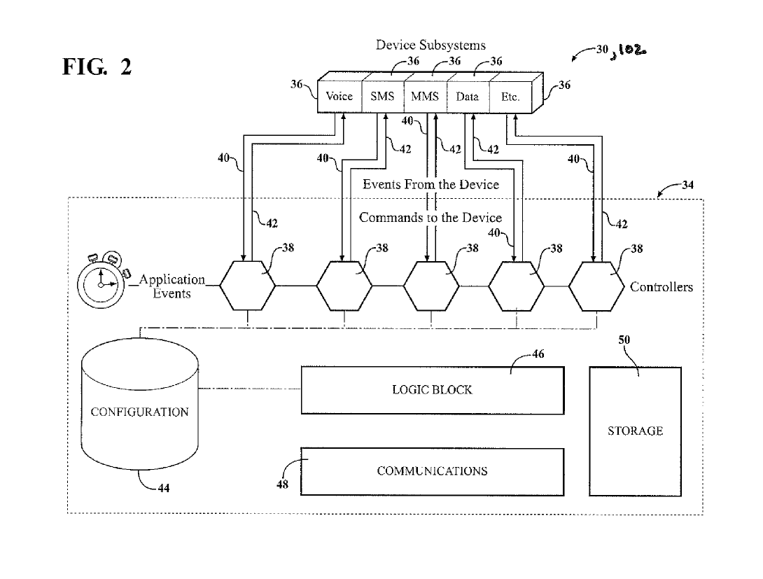

Referring to FIG. 2, the first and second telecommunication devices 22, 24 may operate on a mobile phone network 26. The mobile phone network 26 is often referred to as a cellular phone network, cell phone network, or a telecommunication network, as known in the art. The first and second telecommunication devices 22, 24 and the mobile phone network 26 may utilize any analog and/or digital cellular technology, including, but not limited to, GSM, GPRS, CDMA, EV-DO, EDGE, 3GSM, DECT, TDMA, and iDEN.

Alternatively, the first and second telecommunication devices 22, 24 may communicate via a network 28 such as the Internet. For example, the first and second telecommunication devices 22, 24 may be IP phones or mobile phones having WiFi connectivity. Of course, it is to be appreciated that other techniques for facilitating communications between the first telecommunication device 22 and the second telecommunication device 24 may be employed without deviating from the scope of the present disclosure.

A software application 30 is loaded on to the first telecommunication device 22 for configuring the device 22 for use with the computerized system 20. The software application 30 may be modified or reconfigured dynamically by commands or instructions sent from the server computer 32. The software application 30 is typically sent from a server computer 32 on a central server to the first telecommunication device 22. The software application 30 is typically loaded onto the first telecommunication device 22 via over-the-air (OTA) techniques. In other words, the software application 30 may be loaded on to the first telecommunication device 22 through the mobile phone network 26 or other network 28, without having to physically connect the first telecommunication device 22 to another piece of equipment. However, it is to be appreciated that other techniques for loading the software application 30 onto the first telecommunication device 22 may be employed without deviating from the scope of the present disclosure. For example, the software application 30 may also be loaded by texting a link to the client. When the client clicks on the link, the link takes them to a website where they can download the application software.

As shown in FIG. 2, architecture 34 of the software application 30 is illustrated. Each of the telecommunication devices 22, 24 include a plurality of subsystems 36. The subsystems 36 each manage and execute at least one function on the telecommunication devices 22, 24. The subsystems 36 typically include, but are not limited to: a voice subsystem, a data subsystem, an email subsystem, a Wi-Fi subsystem, a SMS subsystem, a MMS subsystem, a global positioning system (GPS) subsystem, a device power subsystem, and a user interface. The user interface enables the user to interact with the telecommunication device 22, 24. In an example, the user interface 36 includes hardware component(s) that enable a user to input information into the device 22, 24 and/or enable the device 22, 24 to output information to the user. Non-limiting examples of such hardware component(s) are keypads, touch screens, and microphones. The user interface 36 illustrated in the example of the telecommunication device 22, 24, depicted in FIG. 5 includes a screen and a keypad.

It is to be appreciated that any or all of the subsystems 36 may be incorporated into each of the telecommunication devices 22, 24. It is to be further appreciated that additional subsystems 36 may also be utilized without deviating from the scope of the present disclosure.

The software application 30 comprises a plurality of controller modules 38. The controller modules 38 are in communication with the subsystems 36. More specifically, one of the controller modules 38 is linked to one of the subsystems 36 on the first telecommunication device 22. Accordingly, the controller modules 38 typically include, but are not limited to: a voice controller, a data controller, an email controller, a Wi-Fi controller, a SMS controller, a MMS controller, a GPS controller, and a device power controller. For example, the voice controller is typically linked to the voice subsystem, the SMS controller is typically linked to the SMS subsystem, etc. It is to be appreciated that additional controller modules 38 may also be incorporated into the software application 30 without deviating from the scope of the present disclosure. Additionally, the controller modules 38 may send commands from the software application 30 to the first telecommunication device 22 for controlling the device 22. For example, the SMS controller may send a command to the first telecommunication device 22 for telling the device 22 to send a text message or to make a phone call.

Device event messages 40 are created by the subsystems 36 when one of the respective functions is executed on one of the telecommunication devices 22, 24. Said differently, the first telecommunication device 22 generates one of the device event messages 40 each time a phone call is made, a text message is sent, etc. Accordingly, each of the device event messages 40 are sent to one of the specific controller modules 38 for executing a predetermined function bound to that specific device event message.

Application event messages 42 are generated by the software application 30 at predetermined time intervals, such as every 10 seconds. The application event messages 42 are sent to all of the controller modules 38, typically simultaneously. The application event messages 42 may be used to perform various functions of any or all of the controller modules 38.

The software application 30 also includes a configuration script 44. The configuration script 44 is in communication with the controller modules 38 for controlling functionality of the software application 30 and the first telecommunication device 22. The configuration script 44 is preferably written in a programming language that may be understood or interpreted by various operating systems, such as but not limited to, both the BlackBerry OS and iOS. In one embodiment, extensible markup language (XML) is used to allow interpretation across multiple operating systems and programming languages. XML is widely used in the art for the representation of arbitrary data structures and is used to integrate data from other applications or to execute commands from different operating system. Utilizing XML allows the software application 30 to be used with various types of telecommunication devices that run different operating systems without having to significantly change, if at all, the configuration script 44. In other words, the configuration script 44 does not need to be unique for each operating system and/or telecommunication device. It is to be appreciated that other suitable programming languages may also be utilized without deviating from the scope of the present disclosure.

The configuration script 44 comprises a plurality of scriptlets (not separately shown). The scriptlets are typically executed at the start-up of the first telecommunication device 22 or during normal operation of the device 22. The scriplets are generally structured into a plurality of commands for providing at least one instruction. Each of the commands includes a target. The target directs the instruction to one of the controller modules 38 for performing a function. The command typically also includes the instruction and at least one parameter for modifying the instruction. An exemplary structure of the command will now be described. The target and the instruction are separated by a decimal point. The parameters are generally separated by spaces. Each command is separated from one another by a new line. A typical command may be structured as follows:

[target].[instruction]<parameter X><parameter Y>

The scriptlets are typically associated with a specific event message. The specific event message may be one of the device event messages 40 or one of the application event messages 42. Alternatively, one of the scriptlets may be associated with one of the device event messages 40 and one of the application event messages 42. It is to be appreciated that there is no particular restriction on the target within each of the scriptlets. For example, the SMS controller can be directed to interact with the voice controller, or any other one of the controller modules 38.

Each of the commands may be used to influence a subsequent command. A last in, first out (LIFO) stack may be utilized to pass data from one of the commands to the subsequent command. For example, after one of the commands is executed, a value is created. The value is then sent to a subsequent command as one of the parameters of the subsequent command. A lifecycle of the LIFO stack is typically limited to a duration of event processing, i.e., the length of time required to process the device event messages 40 or the application event messages 42. It is to be appreciated that other methods of interaction between the commands may also be utilized without deviating from the scope of the present disclosure.

The software application 30 further includes a logic block 46 in communication with the configuration script 44. The logic block 46 is typically not in direct communication with the controller modules 38 or the telecommunication device 22. The logic block 46 provides processing functions for the configuration script 44. Specifically, the logic block 46 provides the processing functions for portions of the configuration script 44 that are not directly associated with a specific controller. The configuration script 44 includes control commands that do not affect any of the controller modules 38 or the telecommunication device 22. The control commands are necessary for the configuration script 44 to function properly. As an example, the control commands may control the execution flow of the configuration script 44.

The software application 30 still further includes a communications block 48. The communication block enables communication between the first telecommunication device 22 and the server computer 32. Specifically, the server computer 32 sends updates and commands to the configuration script 44 via the communications block 48, and receives the notifications or messages from the device 22 via the communications block 48. The communications block 48 typically comprises a plurality of configurable queues and a link for connecting to the server computer 32. The queues store messages destined for the server 32. The messages may include the device event messages 40 and/or the application event messages 42 generated on the first telecommunication device 22. The link is further defined as an http link or an https link. The link attempts to flush the queues to the server at a predetermined time for each of the queues such that each of the queues has a priority. This predetermined time is further defined as a configurable timeout. The queues are substantially similar to one another and typically only differ in the priority in which each of the queues is sent, i.e., emptied, to the server.

The software application 30 also includes a storage component 50. The storage component 50 is typically used to store persistent device memory. Persistent device memory is a term used to describe memory in which the contents thereof are preserved when the device 22 is powered off and which is accessible when the device 22 is powered on. For example, the configuration script 44 is typically stored in the storage component 50. Additionally, if one of the queues cannot be emptied to the server, or if the queue can only be partially emptied, the queue or portion thereof may be saved in the storage component 50. The queue may not be emptied or only be partially emptied if a signal between the device 22 and the network 26, 28 cannot be established, if the signal is too weak to transfer the data within the queue, and/or if the signal is dropped, i.e., becomes disconnected, during transmission of the data from the queue. Also, the controller modules 38 may save data to the storage component 50, especially if that data is needed when the device 22 is powered on.

In one embodiment, the computerized system 20 is utilized for recording transactional and usage data between the first and second telecommunication devices 22, 24. The software application 30 may be loaded onto the first telecommunication device 22 via the OTA technique described above. The software application 30 captures transactional data streams and transmits these transactional data streams as described in greater detail below.

The server computer 32 is in communication with the first telecommunication device 22. The server computer 32 is implemented as an application server 52 and a data store 54. Of course, multiple server computers with one or more application servers and data stores may be implemented without deviating from the scope of the present disclosure.

A monitoring acknowledgement request is sent to the first telecommunication device 22 from the server computer 32 in response to the software application 30 being loaded onto the first telecommunication device 22. This request is typically implemented as a character-based message. The computerized system 20 may require confirmation of receipt of the monitoring acknowledgement request by the first telecommunication device 22 prior to allowing functionality thereon. For example, the request may ask, “do you understand that any use of this device, including all voice conversations and text messages, may be recorded and utilized by others?” The computerized system 20 then requires that a confirmation message be sent back to the server computer 32. For example, the confirmation message may be the word “Yes” or simply the letter “Y”.

The software application 30 being executed on the first telecommunication device 22 streams the transactional data from the first telecommunication device 22 to the server computer 32. The data, collectively referred to as communication data, captured by the software application 30 on the first telecommunication device 22, and collected by the server computer 32, includes, but is not limited to, call records (both inbound and outbound), text messaging data (inbound/outbound transactions as well as message content), and multi-media messaging data (inbound/outbound transactions as well as message content). Typically, most data traffic is from the first telecommunication device 22 to the server computer 32. However, the download of the software application 30 to the first telecommunication device 22 as well as commands to remotely lock and wipe the first telecommunication device 22 will be sent from the server computer 32 to the first telecommunication device 22. Data in a broader sense may also include information from other applications that reside on the telecommunication devices. For example, software application 30 may be configured to monitor a calendar application on the device such that data relating to scheduled client meetings are recorded. The data may include the name of the client, the time and length of the meeting, and any other information that is available from the application. The user is then prompted to categorize the meeting as billable, non-billable or uncategorized. In addition, software application 30 may also be configured to pull GPS data for grabbing data on travel. The user is again prompted to categorize the meeting as billable, non-billable or uncategorized. The “call records” may include data representing all or part of an audible conversation between the first telecommunication device 22 and the second telecommunication device 24. As such, both the first telecommunication device 22 and the server computer 32 include a recording component (not separately numbered) for recording the communications between the first and second telecommunication devices 22, 24.

The application server 52 receives the transmissions of the transactional data from the first telecommunication device 22 and aggregates this transactional data into flat files. The flat files are then collected and pushed to the data store 54 using a mediator 56, also referred to as a mediation bridge. The mediator 56 ensures that all the collected files are backed- up, archived, and distributed to the data store 54 and that the original files on the application server 52 are destroyed.

The data store 54 enriches the transaction records with subscriber profile information that is stored and maintained as master records for each of the subscribers utilizing the telecommunication devices 22, 24. The enriched data sets are then made available to data consumers through an exposed application programming interface (API) layer to facilitate data viewing, interaction with the data sets and also data integrations to third-party applications.

The data store 54 also allows for configuration of multiple compliance policies of which any one or more can be deployed against any line of business, logical group or individual subscriber. The computerized system 20 uses an inheritance model to “inherit” compliance policies (or compliance business rules) and apply these against groups and subscribers, where such groups and subscribers may be assigned multiple compliance policies. This enables advanced configuration of the business rules (both for data recording and data viewing).

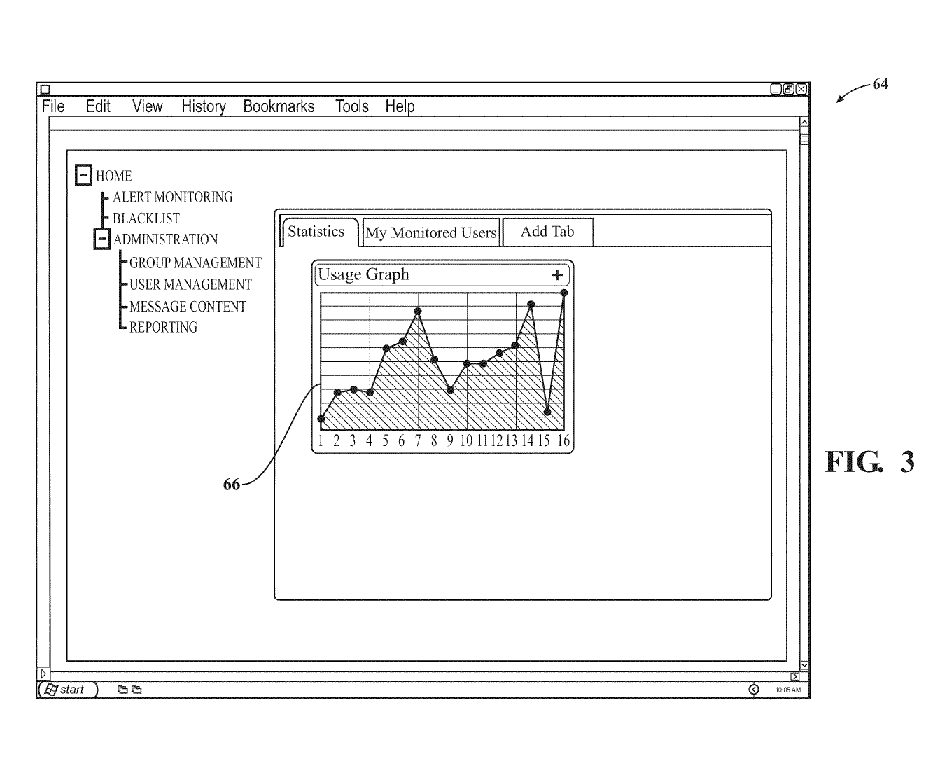

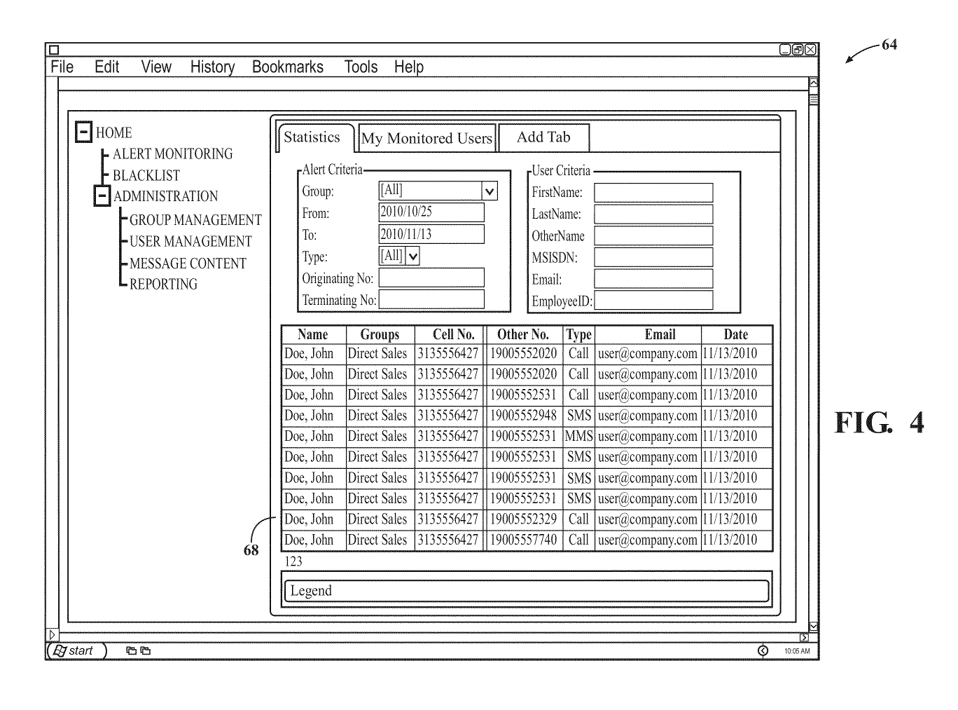

The computerized system 20 includes at least one interface 58 for relaying the content of the data store 54 to a separate storage system 60, to a consumer (not numbered), or other applicable device (not shown). The content may be presented to the consumer in a plurality of forms using any number of techniques known in the art. In one instance, the content may be presented via a computer 62. Specifically, a web browser 64 running on the computer 62, as shown in FIGS. 3 and 4. FIG. 3 shows a graph 66 displaying usage of the first telecommunication device 22. FIG. 4 shows a detailed listing 68 of telephone calls made and text messages exchanged using the first telecommunication device 22.

The computerized system 20 may also store a list of persons and/or organizations to which the first user is not permitted to contact. For example, the list, e.g., a “black list”, may include the phone numbers of business competitors, former employees, etc. An alert may be sent to a third party, e.g., the computer 62, when communication between the first telecommunication device 22 and a person and/or organizations on the list.

Furthermore, the computerized system 20 may provide a convenient display of all communications between the first telecommunication device 22 and second telecommunication device, such as a person or organization on the list. For instance, the system 20 may display a timeline (not shown) of each individual communications which allows the consumer to see exactly what form of communication was utilized along with the content of each communication. In one example, the computerized system 20 may display, on one “screen” of the computer 62, a phone call received on a first day of a month, a text message sent on a second day of a month, an email received on a third day of a month, and a data file transmitted on a fourth day of a month.

Referring again to FIG. 1, the computerized system 20 preferably includes a plurality of firewalls 70 to prevent unauthorized or malicious transfer of data, i.e., “hacking”, from the server computer 32. For example a first firewall 70a is implemented between the first telecommunication device 22 and the application server 52 to prevent access of data from the first telecommunication device 22. Additionally, a second firewall 70b is implemented between the data store 54 and the separate storage system 60 and a third firewall 70c is implemented between the data store 54 and the consumers via the interface 58.

In one particular embodiment, software application 30 is a billing application 102 that is used to track and categorize communications between telecommunication devices 22, 24. Billing application 102 is configured such that each tracked and recorded data communication can be categorized, for example, as either a billable, non-billable, or uncategorized communication. As understood by one of ordinary skill in the art, these specific categorizes are exemplary. Other categories may be created to meet varying system requirements and client or customer specific criteria. Once collected and categorized as billable, a communication or call record may be transmitted to the client computer 62 so that the information contained in the communication record can be implemented (either manually or automatically) into a client billing system.

Like software application 30, billing application 102 is stored in the computer-readable storage medium of the processor 100 of the telecommunication device 22 and/or the telecommunication device 24. For purposes of illustration, the application 102 is stored in the computer-readable storage medium of the processor 100 of the telecommunication device 22. The application 102 includes computer-readable instructions for instructing the processor 100 to begin recording data as soon as the telecommunication device 22 initiates an outbound call or receives an inbound call. The application 102 includes computer-readable instructions for instructing the processor 100 to start a timer as soon as the telecommunication device 22 initiates the outbound call or receives the inbound call. The data may include, but is not limited to, the time at which the outbound call was initiated, the time at which the inbound call was initiated, the dialing number of the telecommunication device 22 initiating the outbound call or receiving the inbound call, the dialing number of the other telecommunication device (such as the telecommunication device 24) that is party to the call, content of any voice data recorded during the call, a duration of the call, the direction of the call (e.g. inbound or outbound), and/or other data relevant to the call.

It is to be understood that the application 102 instructs the processor 100 to record data as soon as the telecommunication device 22 initiates or receives other types of communication. For instance, the application 102 may instruct the processor 100 to record data as soon as the telecommunication device 22 initiates or receives a short message service (SMS) message, an email, or the like.

In instances where the telecommunication device 24 answers the outbound call initiated by the telecommunication device 22 or the telecommunication device 22 answers the inbound call initiated by the telecommunication device 24, the telecommunication devices 22, 24 are said to be engaged in a communication. Data is continuously recorded until the communication between the telecommunication devices 22, 24 is complete. The communication between the telecommunication devices 22, 24 is complete when the telecommunication devices 22, 24 disconnect. However, where the telecommunication device 24 does not answer the outbound call initiated by the telecommunication device 22 or the telecommunication device 22 does not answer the inbound call initiated by the telecommunication device 24, the telecommunication devices 22, 24 did not engage in a communication. It is to be understood, however, that data is still recorded even though a communication between the telecommunication devices 22, 24 did not actually occur. Data is recorded in these instances until the telecommunication device 22 ends the outbound call, or until the telecommunication device 24 ends the inbound call.

In an example, a communication record based on the recorded data is created in response to instructions from the application 102. In the present embodiment, the communication record may contain all of the recorded data, including identification information of the telecommunication device 22, the dialing numbers of the telecommunication devices 22, 24, direction of the communication (e.g. an inbound call or an outbound call), the start time and duration of the communication, and/or voice data. In instances where the communication is an SMS message, the communication record may include identification of the telecommunication device 22, the dialing number of the telecommunication devices 22, 24, the direction of the SMS message, the start time and duration of the SMS communication, and/or text data. Further, in instances where the communication is an email, the communication record may include identification information of the telecommunication device 22, email addresses associated with the telecommunication devices 22, 24, the direction of the email communication, the start time and duration of the email communication, and/or text data.

In an example, the communication record also includes notes related to the communication. More specifically, the application 102 instructs the processor 100 to prompt the user to edit the call record. Prompting may be accomplished, for example, by presenting a message on the screen portion of the user interface 36 of the telecommunication device 22 asking the user if he/she wishes to edit the communication record. The user may respond with a “yes” by selecting an appropriate key on the keypad of the user interface 36. In instances where the telecommunication device 22 has a touchscreen interface, the user may respond with a “yes” by touching the appropriate icon presented on the touchscreen. Alternatively, the telecommunication device 22 may include a speech recognition program, which is executable by the processor 100, and may recognize a verbal recitation of the word “yes” by the user utilizing a microphone. In instances where the user does not wish to edit the communication record, he/she will input a “no” into the user interface 36 (utilizing any of the methods mentioned above) in response to the prompt.

The communication record, which may be edited or not edited, is thereafter stored in the storage compartment 50 of the application 102.

After the communication record is created, the application 102 prompts the user to designate the communication record as being associated with a billable communication, a non-billable communication, or an uncategorized communication. In an example, prompting may be accomplished by presenting an actionable item 106 on the screen portion of the user interface 36 that, when selected, initiates an action. As shown in FIG. 5, the actionable item 106 may be a bar presented on the screen portion of the user interface 36, where the bar includes a movable icon that may be moved (e.g. dragged by the user's finger) from one position to another. In an example, the application 102 sets the uncategorized communication as a default category. Accordingly, the icon may be initially located on the bar at a position designating the call record as being associated with an uncategorized communication. The bar further includes positions designating the communication record as being associated with a billable communication and a non-billable communication. The user may designate the billable communication by moving the icon (such as by dragging the icon across the screen) to the position designating the communication record as being associated with a billable communication. Likewise, the user may designate the non-billable communication by moving the icon (such as by dragging the icon across the screen) to the position designating the communication record as being associated with a non-billable communication.

In another example, which is not shown, billable, non-billable, and uncategorized communications may individually be represented by an icon presented on the screen of the user interface 36. Accordingly, the user may designate the communication record as being associated with a billable communication by selecting the billable icon (e.g. by touching the icon on a touch screen). The user may otherwise designate the communication record as being associated with a non-billable communication by selecting the non-billable icon. Further, the user may designate the communication record as being associated with an uncategorized communication by selecting the uncategorized icon.

It is to be understood that communications that are uncategorized include those that generally do not involve a client. Examples of uncategorized communications include personal communications, such as communications with a relative, communications with a friend, and/or other communications made predominately for personal reasons. Furthermore, communications that are billable include those that may or should be billed to a client, while non-billable communications are those that should not be billed to a client.

In instances where the user designates the communication record as being associated with a non-billable communication, the application 102 removes the communication record from the storage compartment 50. By removing the communication record from the storage compartment 50, the entire communication record is deleted. Removal of the communication record from the storage compartment 50 may be accomplished automatically or after a preset time (e.g. at least 10 seconds after designating the communication record as being associated with a non-billable communication).

In instances where the user designates the communication record as being associated with a billable communication, in one example, the application 102 automatically uploads the communication record stored in the storage compartment 50 to the server computer 32. In another example, when user designates the communication record as being associated with a billable communication, the application 102 generates a prompt that is presented on the screen portion of the user interface 36 asking the user if he/she wishes to edit the communication record as previously described. Again, the user may select to edit the communication record by adding notes related to the communication to the communication record.

The communication record is uploaded to the server computer 32 over a generally secure connection, such as an HTTPS connection. Additionally, the contents of the communication record may be encrypted or otherwise coded for additional security. Further, when the communication record is successfully uploaded to the server computer 32 the communication record is deleted from the storage compartment 50. It is to be understood that when the communication record is not successfully uploaded to the server computer 32, the communication record will remain in the storage compartment 50 for a predefined amount of time (e.g. 12 hours, 10 days, etc.) or until the user elects to delete the communication record from the storage compartment 50. The user may elect to delete the communication record by retrieving the communication record from the storage compartment 50 and then activating a delete function utilizing the user interface 36.

In an example, the application 102 stores a number of communication records from a number of different communications between the telecommunication device 22 and other telecommunication devices. The application 102 may further upload all of the communication records to the server computer 32 at the same time. In this example, the communication record(s) may be uploaded to the server computer 32 at prescribed intervals (e.g., every 5 hours, every 10 hours, once a day, or the like). For instance, a first communication record may be created for a first communication between the telecommunication device 22 and the telecommunication device 24. Then, a second communication record may be created for a second communication between the telecommunication device 22 and a third telecommunication device (not shown). The two communication records may be stored in the storage compartment 50 until both are uploaded together to the server computer 32 at time t₁. Afterwards, a third communication record may be created for a third communication between the telecommunication device 22 and a fourth telecommunication device (not shown), and a fourth communication record may be created for a fourth communication between the telecommunication device 22 and a fifth telecommunication device (not shown). The third and fourth communication records may be stored in the storage compartment 50 until both are uploaded to the server computer 32 at time t₂.

The application server 52 at the server computer 32 receives the communication record from the telecommunication device 22. The data store 54 instructs the server computer 32 to reformat the contents of the communication record into a suitable form for transmission to the client computer 62. In instances where the communication record is encrypted or coded, the data store 54 will instruct the server computer 32 to decrypt or decode the contents of the communication call record prior to reformatting. In example, the data store 54 instructs the server computer 32 to extract identification information of the telecommunication device 22 from the uploaded communication record, and utilizes this information to identify the telecommunication device 22. Such identification information is also used to obtain identification information of the client computer 62. More specifically, the identification information of the telecommunication device 22 is used to look up the identification information of the client computer 62 (to which the reformatted communication record is to be transmitted) stored in a database in a storage medium of the server computer 32. In another example, the server computer 32 extracts the identification information from the uploaded communication record, and utilizes this information to identify the telecommunication device 22 so that the server computer 32 can store the communication record in the database. In this example, the communication record may be forwarded to the client computer 62 at a later time, either alone or in combination with one or more other communication records. The communication record(s) may then be forwarded to the client computer 62 at prescribed intervals (e.g., every 5 hours, every 10 hours, once a day, or the like).

In an example, the client computer 62 is a user station or computer at the business place of the user. Examples of user stations or computers include the user's personal computer, the personal computer or workstation of the user's assistant, a personal computer or workstation of the accounting department at the user's business place, or the like. In this example, the communication record may be reformatted by the server computer 32 in an email format, a portable document format (pdf), a word processer format, or the like. In another example, the client computer 62 is a computer at the user's business place that includes an internal billing system. In this example, the server computer 32 reformats the communication record into a format suitable for use by the internal billing system.

The system disclosed herein may be implemented on one or more suitable computing devices, which generally include applications that may be software applications tangibly embodied as a set of computer-executable instructions on a computer readable medium within the computing device. The computing device may be any one of a number of computing devices as set forth above.

Computing devices generally each include instructions executable by one or more devices such as those listed above. Computer-executable instructions may be compiled or interpreted from computer programs created using a variety of programming languages and/or technologies, including without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable media includes any medium that participates in providing data (e.g., instructions), which may be read by a computing device such as a computer. Such a medium may take many forms, including, but not limited to, non-volatile media, volatile media, and transmission media. Non-volatile media includes, for example, optical or magnetic disks and other persistent memory. Volatile media include dynamic random access memory (DRAM), which typically constitutes a main memory. Common forms of computer-readable media include any medium from which a computer can read.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claim, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A method of tracking communications between telecommunication devices, said method being implemented on a processor of a first telecommunication device, the processor having a non-transitory computer-readable storage medium with an executable application stored thereon, said method comprising the step of:
executing the application stored on the computer-readable storage medium, wherein the application instructs the processor to:
record data relating to the first telecommunication device;
create a record from the recorded data; and
prompt a user to designate the record as billable, non-billable, or uncategorized.

2. The method as set forth in claim 1 wherein the data is recorded upon an outbound call being initiated by the first communications device or an inbound call being received by the first communications device.

3. The method as set forth in claim 1 wherein the application further instructs the processor to initiate a timer when the first telecommunication device initiates an outbound call or receives an inbound call.

4. The method as set forth in claim 1 wherein the application further instructs the processor to store the record in a storage component when the record is created.

5. The method as set forth in claim 4 wherein the application further instructs the processor to remove the record from the storage component once the record is designated as non-billable.

6. The method as set forth in claim 4 wherein the application further instructs the processor to upload the record stored in the storage component to a server computer once the record is designated as billable.

7. The method as set forth in claim 1 wherein the application further instructs the processor to prompt a user to edit the record.

8. The method as set forth in claim 4 wherein the application further instructs the processor to remove the record from the storage compartment after uploading the record to a server computer.

9. The method as set forth in claim 6 further comprising the steps of:
reformatting the uploaded record; and
forwarding the reformatted record to a client computer.

10. The method as set forth in claim 9 further comprising the steps of:
extracting information from the uploaded record; and
storing the uploaded record in a database based on the extracted information.

11. The method as set forth in claim 1 wherein the recorded data is data that includes at least one of call records, text messaging data and multi-media messaging data, calendar events, GPS information, device event messages and application event messages.

12. A system for tracking communications between telecommunication devices, the system comprising:
a server computer in communication with a first telecommunication device and configured to download an application to the first telecommunication device, the application being executable by a processor of the first telecommunication device and comprising computer-readable instructions for:
recording data between the first telecommunication device and a second communications device;
creating a record from the recorded data; and
prompting a user to designate the record as billable communication, non-billable, or uncategorized.

13. The system as set forth in claim 12 wherein the data is recorded upon an outbound call being initiated by the first communications device or an inbound call being received by the first communications device.

14. The system as set forth in claim 12 wherein the application further comprises computer-readable instructions for initiating a timer when the first telecommunication device initiates an outbound call or receives an inbound call.

15. The system as set forth in claim 12 wherein the application further comprises computer-readable instructions for storing the record in a storage component when the record is created.

16. The system as set forth in claim 15 wherein the application further comprises computer-readable instructions for removing the record from the storage component of once the record is designated as non-billable.

17. The system as set forth in claim 15 wherein the application further comprises computer-readable instructions for uploading the record stored in the storage component to the server computer once the record is designated as billable.

18. The system as set forth in claim 12 wherein application further comprises computer-readable instructions for prompting a user to edit the record.

19. The system as set forth in claim 17 wherein the application further comprises computer-readable instructions for removing the record from the storage compartment after the record is uploaded to the server computer.

20. The system as set forth in claim 12 wherein the server computer comprises a data store for reformatting an uploaded record.

21. The system as set forth in claim 20 wherein the data store is further configured to:
extract information from the uploaded record; and
store the uploaded record in a database based on the extracted information.

22. A system for tracking communications between first and second telecommunication devices, the system comprising:
a server computer in communication with the first telecommunication device, the server computer comprising:
an application server for receiving a record from the first telecommunication device upon categorizing a communication between the first and second telecommunication devices; and
a data store reformatting the record for transmission to a client computer.
